(19) United States
(12) Patent Application Publication
(10) Pub. No.: US 2022/0405140 A1
(43) Pub. Date: Dec. 22, 2022

(54) SECURITY SYSTEM AND CONTROL METHOD THEREOF

(71) Applicant: SKYREC Inc., Taipei City (TW)

(72) Inventors: Kai-Shian MOOI, Taipei City (TW); Chun-Wei LIAO, Taipei City (TW)

(21) Appl. No.: 17/807,387

(22) Filed: Jun. 17, 2022

Related U.S. Application Data
(60) Provisional application No. 63/211,565, filed on Jun. 17, 2021.

(51) Int. Cl. G06F 9/50

(52) U.S. Cl. CPC G06F 9/5005

(57) ABSTRACT

A security system is disclosed. The security system includes a memory and a processor. The memory is configured to store several applications, in which several applications include several relationships. The processor is coupled to the memory, in which the processor is configured to manage several applications according to several relationships and at least one of a time driven method and an event driven method, in which the several relationships include a parent-child relationship, a function-group relationship, and an app-type relationship, to receive several input signals from several sources, and to display a screen picture of the several input signals according to several drawing parameters, and when several applications are running, the processor is further configured to allocate several resources of the security system to several applications according to several weighting values.

### CROSS-REFERENCE TO RELATED APPLICATION

This application claims priority to U.S. Provisional Application Ser. No. 63/211,565, filed Jun. 17, 2021, which is herein incorporated by reference.

### FIELD OF INVENTION

The present application relates to a security system and a control method thereof. More particularly, the present application relates to a security system and a control method controlling several applications.

### BACKGROUND

In a security system, several applications may be executed at the same time, an efficient way for managing the applications is in need. Furthermore, the security system may be connected to several cameras or other devices, when the cameras or other devices, which include different input signals, send messages to the security system, a method for merging the input signals is also in need. Moreover, an efficient way is also in need for allocating the resources to the applications.

### SUMMARY

The disclosure provides a security system. The security system includes a memory and a processor. The memory is configured to store several applications, in which several applications include several relationships. The processor is coupled to the memory, in which the processor is configured to manage several applications according to several relationships and at least one of a time driven method and an event driven method, in which the several relationships include a parent-child relationship, a function-group relationship, and an app-type relationship, to receive several input signals from several sources, and to display a screen picture of the several input signals according to several drawing parameters, and when several applications are running, the processor is further configured to allocate several resources of the security system to several applications according to several weighting values.

The disclosure provides a control method, suitable for a security system. The security system includes several applications with several relationships. The control method includes the following operations: managing several applications according to several relationships and at least one of a time driven method and an event driven method by a processor of the security system, wherein the several relationships comprise a parent-child relationship, a function-group relationship, and an app-type relationship; receiving several input signals from several sources and displaying a screen picture of the plurality of input signals according to several drawing parameters by the processor; and allocating several resources of the security system to several applications according to several weighting values by the processor when the several applications are running.

It is to be understood that both the foregoing general description and the following detailed description are by examples and are intended to provide further explanation of the invention as claimed.

### BRIEF DESCRIPTION OF THE DRAWINGS

Aspects of the present disclosure are best understood from the following detailed description when read with the accompanying figures. It is noted that, according to the standard practice in the industry, various features are not drawn to scale. In fact, the dimensions of the various features may be arbitrarily increased or reduced for clarity of discussion.

FIG. 1 is a schematic diagram illustrating a security system according to some embodiments of the present disclosure.

FIG. 2 is a flowchart illustrating a control method according to some embodiments of the present disclosure.

FIG. 3 is a schematic diagram illustrating the memory as illustrated in FIG. 1 according to some embodiments of the present disclosure.

FIG. 4 is a schematic diagram illustrating a screen picture according to some embodiments of the present disclosure.

FIG. 5 is a schematic diagram illustrating an allocation example according to some embodiments of the present disclosure.

FIG. 6 is a schematic diagram illustrating another allocation example according to some embodiments of the present disclosure.

FIG. 7 is a schematic diagram illustrating an example of resource allocation according to some embodiments of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

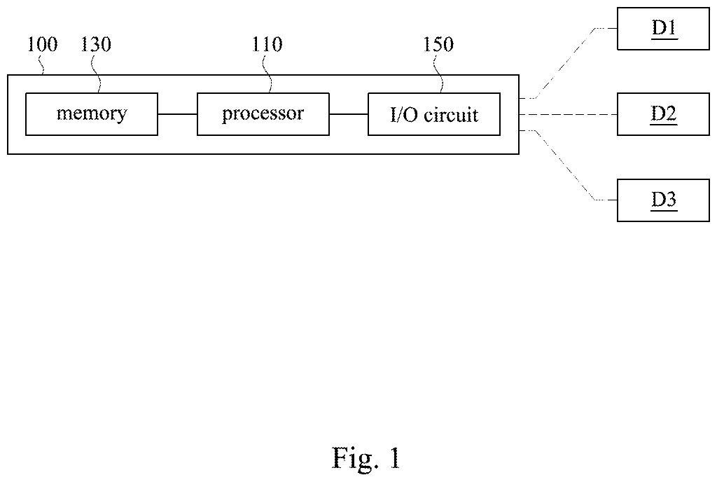

Reference is made to FIG. 1. FIG. 1 is a schematic diagram illustrating a security system 100 according to some embodiments of the present disclosure. As shown in FIG. 1, the security system 100 includes a processor 110, a memory 130, and an I/O circuit 150. In some embodiments, the processor 110 is coupled to the memory 130 and the I/O circuit 150.

As illustrated in FIG. 1, the security system 100 is coupled to the cameras D1 to D3. In some embodiments, the cameras D1 to D3 are disposed in the shop or other places. The cameras D1 to D3 are configured to capture images or videos of the environment surrounding the cameras D1 to D3, and the cameras D1 to D3 send the captured images or videos to the security system 100. The number of the cameras D1 to D3 is of illustrative purposes only, and the embodiments of the present disclosure are no limited thereto.

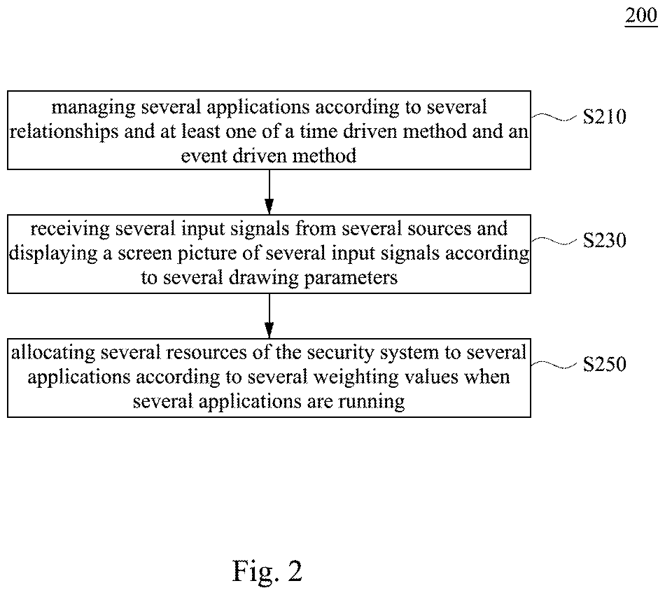

Reference is made to FIG. 2. FIG. 2 is a flowchart illustrating a control method 200 according to some embodiments of the present disclosure. The control method 200 is suitable to be executed by the security system 100 in FIG. 1. The control method 200 includes operations S210 to S250.

In operation S210, several applications are managed according to several relationships between the applications and at least one of a time driven method and an event driven method. In some embodiments, operation S210 is operated by the processor 110 as illustrated in FIG. 1.

In some embodiments of the present disclosure, several applications are stored by a memory as illustrated in FIG. 1. Several applications include several relationships. In some embodiments, the relationships between the applications include a parent-child relationship, a function-group relationship, and an app-type relationship.

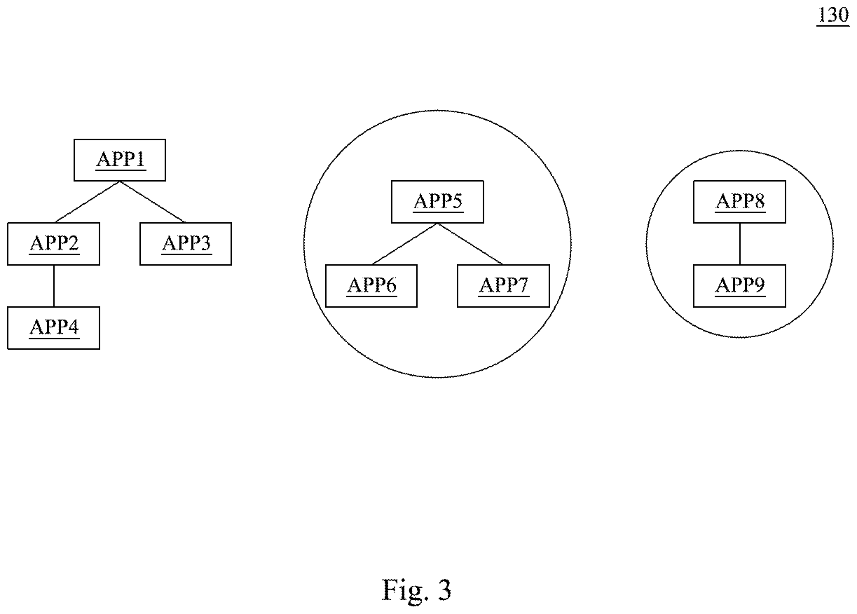

Reference is made to FIG. 3 at the same time. FIG. 3 is a schematic diagram illustrating the memory 130 as illustrated in FIG. 1 according to some embodiments of the present disclosure. As illustrated in FIG. 3, the memory 130 stores applications APP1 to APP5. The relationships between the applications APP1 to APP4 are the parent-child relationships. The application APP1 works as a parent application of the applications APP2 and APP3, and the application APP2 works as a parent application of the application APP4. In some embodiments, the applications APP1 to APP4 are in a same family group. The relationships between the applications APP5 to APP7 are the function-group relationship. That is, the applications APP5 to APP7 are in the same function group. In some embodiments, the function groups include the video analytics function group, the business intelligent function group, the video management system function group, the system setting function group, the command desk system function group, and so on. The relationship between the applications APP8 and APP9 is the app-type relationship. That is, the applications of APP8 and APP9 are the same application.

In some embodiments, operation S210 includes the following operations: several messages between several applications are sent according to several relationships, and several execution statuses of several applications are changed according to several relationships.

Reference is made to FIG. 3 together. In some embodiments, when a relationship between a first relationship between a first application and a second application is the parent-child relationship, and the first application works as a parent application of the second application, the processor 110 sends a message from the first application to the second application. For example, since the application APP1 is the parent application of the applications APP2 to APP4, the application APP1 sends the message to the applications APP2 and APP3, and the application APP2 sends the message to the application APP4.

In some embodiments, when the relationship between the first application and the second application is the function-group relationship, the processor 110 sends the message to the first application and the second application according to the function-group relationship. For example, since the relationship between the applications APP5 and APP6 is the function-group relationship, the processor 110 sends the message to the applications APP5 and APP6 at the same time.

In some embodiments, when the relationship between the first application and the second application is the app-type relationship, the processor 110 sends the message to the first application and the second application according to the app-type relationship. For example, since the relationship between the applications APP7 and APP8 is the app-type relationship, the processor 110 sends the message to the applications APP7 and APP8 at the same time.

In some other embodiments, the processor 110 sends messages from the first application to the second application (one-to-one transmission). In some other embodiments, the processor 110 sends messages to the whole family with the parent-child relationship. In some other embodiments, the processor 110 sends messages to all of the running applications (one-to-all transmission).

According to the paragraphs mentioning above, the embodiments of the present disclosure includes the following information transmission methods: (1) one-to-one transmission (2) one-to-family transmission (3) parent-to-child transmission (4) one-to-(function-group) transmission (5) one-to-(app-type) transmission (6) one-to-all transmission.

In some embodiments, the processor 110 changes the execution statuses of the applications according to the relationships between the applications. The execution statuses of the applications include idle, running, and disable. When an application is opened but not in use, the application is idle. When an application is opened, the application is running. When an application is closed, the application is disable.

In some embodiments, the processor 110 opens(executes) or closes the applications of the same app-type (for example, applications APP7 and APP8 in FIG. 3) at the same time. In some embodiments, the processor 110 opens(executes) or closes the applications of the same function-group (for example, applications APP5, APP6 and APP7 in FIG. 3) at the same time. In some embodiments, the processor 110 closes the applications of the same family group (for example, applications APP1 to APP4 in FIG. 3) at the same time.

In some embodiments, the processor 110 is further configured to manage the applications with a time driven method or an event driven method. When an application is managed with the time driven method, the application is executed or closed when a predetermined time condition is reached. When an application is managed with the event driven method, the application is executed or closed when a predetermined event condition is reached.

In some embodiments, the processor 110 is further configured to control an application to receive or send a message when a predetermined time condition is reached if the application is managed with the time driven method. In some embodiments, the processor 110 is further configured to control the application to receive or send a message when a predetermined event condition is reached if the application is managed with the event driven method.

For an example of the time-driven method, the applications with the function of live monitoring function group are opened(executed) or closed with a fixed time. Another example is that the applications with the function of live video analytic function group are opened(executed) or closed according to the business hours of a shop.

Some other examples of the time-driven method are also disclosed. For example, the application APP1 is configured to download the images from the camera D1 as illustrated in FIG. 1, and the application APP1 sends the downloads images to the application APP2 every fixed time.

For an example of the event-driven method, when a sensor of the door is sends out a warning, the applications with the function of live monitoring function group are opened. Another example is that when the camera detected a man is appeared, the applications with the function of live video analytic function group are opened.

Some other examples of the event-driven method are also disclosed. For example, when one of the cameras is out of signal, application APP1 sends the message to the application APP2. For another example, when the application APP1 founds that one of the cameras is removed, the application APP1 sends the message to all of the running applications, so as to update the camera list.

Reference is made to FIG. 2 again. In operation S230 in FIG. 2, the processor 110 as illustrated in FIG. 2 receives several input signals from several sources and displays a screen picture of several input signals according to several drawing parameters. In some embodiments, the processor 110 merges the input signals from several sources to generate the screen picture. The method of merging the input signals includes programmable conditions, which are also called drawing parameters.

In some embodiments, the programmable conditions are the scripted conditions. In some embodiments, the drawing parameters are adjusted dynamically.

The input signals include a video decode engine, an AI inference engine, a data statistic engine, a GUI render engine, a HTME render engine, a geometry map engine, and a chart render engine, etc.

The drawing parameters include a source (ID) parameter, an input rectangle (cropping) parameter, an output rectangle (resize) parameter, a capture frame rate parameter, a display frame rate parameter, a geometry parameter (box, circle, polygon, line), an alpha composite parameter (transparency), a layer level parameter (for example, level 1 is at the bottom and is drawn first), and a play audio parameter (whether to play the audio or not).

In some embodiments, the processor 110 is further configured to merge the input signals with a horizontal stitching and transparent method, a vertical stitching and covering method, or a vertical stitching and transparent method. With the horizontal stitching method, different input signals are drawn on the same level. With the vertical stitching method, different input signals are drawn on different levels. With the covering method, the upper layer covers the lower layer. With the transparent method, the upper layer does not fully cover the lower layer. The horizontal stitching and transparent method, the vertical stitching and covering method, and the vertical stitching and transparent method are the combinations of two of the horizontal stitching method, the vertical stitching method, the covering method, and the transparent method mentioning above.

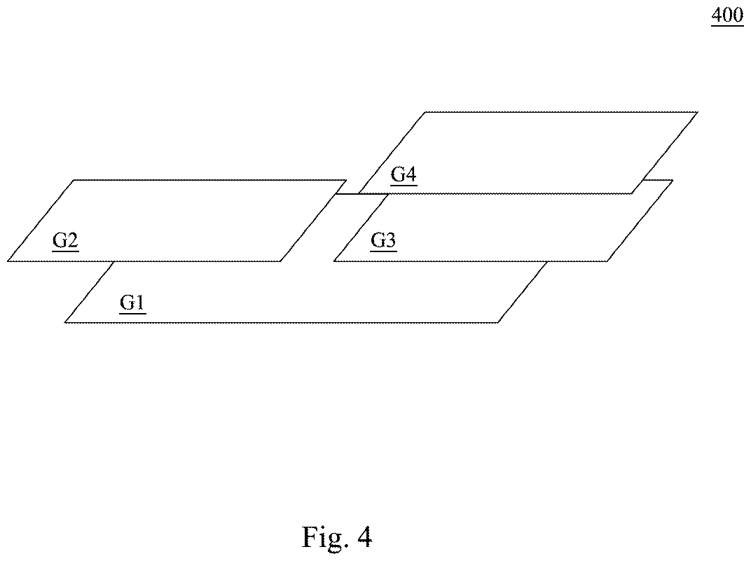

Reference is made to FIG. 4 together. FIG. 4 is a schematic diagram illustrating a screen picture 400 according to some embodiments of the present disclosure. As illustrated in FIG. 4, the pictures G1 to G4 are from different input signals, and the pictures G1 to G4 includes different drawing parameters. For example, the picture G1 includes drawing parameter level #1, the picture G2 includes drawing parameter level #2, the picture G3 includes drawing parameter level #2, and the picture G4 includes drawing parameter level #3. When generating the screen picture 400, the processor 110 draws the picture G1 on the bottom first, draws the pictures G2 and G3 on the middle level, and then draws the picture G4 on the upper level. The pictures G2 and G3 are drawn with the horizontal stitching method, the pictures G1, G3, and G4 are drawn with the vertical stitching method, and the pictures G1 and G2 are drawn with the vertical stitching method.

In some embodiments, the processor 110 is further configured to adjust the drawing parameters according to a time driven method, an event driven method, or a user driver method. The time driven method includes a time condition. The event driven method includes an event condition. The user driven method includes a user condition.

An example of generating the screen picture with the time driven method is disclosed. For example, the drawing parameters include a time condition. The processor 110 generates the screen picture with the input signals from different cameras when the time condition is met, so that the images from different cameras can be displayed with a timed rotation.

Some examples of generating the screen picture with the event driven method are disclosed. For example, the drawing parameters include an event condition. The processor 110 generates the screen picture with the input signal when the event condition is met, so that the image from the specific input signal can be displayed.

For example, when an event condition of a camera being out of signal is met, the image of the camera before the camera being out of signal is displayed. For another example, when an event condition of a door sensor sends an alarm is met, the image including the door sensor is displayed. For another example, when an event condition of a human image being detected by a camera is met, the image of the camera is displayed.

Some examples of generating the screen picture with the user driven method are disclosed. For example, the drawing parameters include a user condition. The processor 110 generates the screen picture with the input signal when the user condition is met, so that the image from the specific input signal can be displayed.

For example, when the security system 100 is set in the central control room and includes a keyboard and a mouse, the processor 110 generates the screen picture according to the input signals from the keyboard and the mouse of the security system 100 in the central control room, and the security system 100 can be controlled by the keyboard and the mouse. When the security system 100 is set out of the central control room and only includes a monitor but does not include a keyboard or a mouse, the processor 110 generates the screen picture according to the input signals from the security system 100 out of the central control room.

Reference is made to FIG. 2 again. In operation S250, the processor 110 as illustrated in FIG. 2 allocates resources of the security system 100 for the applications according to several weighting values when the applications are running.

In some embodiments, the resources include a CPU resource, a GPU resource, a memory resource, a disk storage resource, a disk I/O resource, and a network resource. For an application, for example, the application APP1 in FIG. 3, the application APP1 includes several weighting values, and each of the weighting values corresponds to one of the several resources in correspondence.

The higher the weighting value is, the more the resource is allocated. The lower the weighting value is, the less the resource is allocated. In some embodiments, each of the weighting values includes a maximum weighting value and a minimum weighting value. When the application is focused, the allocated weighting value of each of the resources allocated to the application is higher than the minimum weighting value, and when the application is not focused, the allocated weighting value of each of the resources allocated to the application is lower than the maximum weighting value.

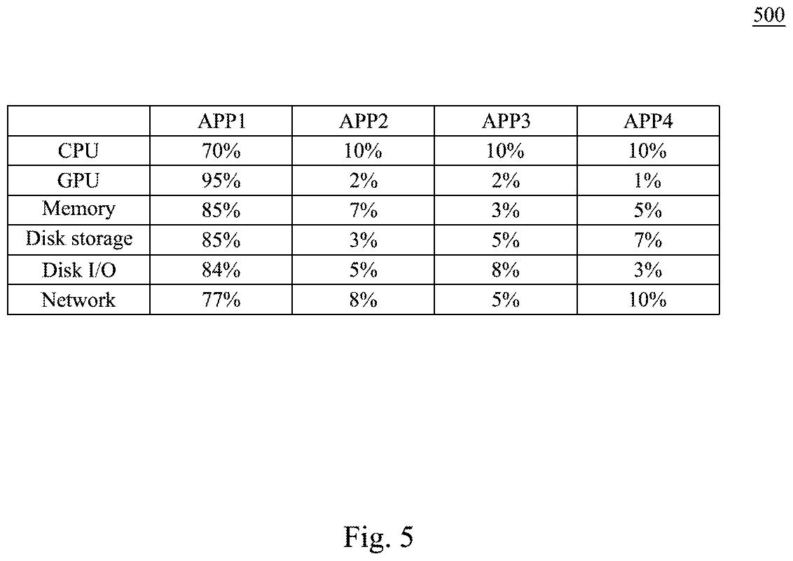

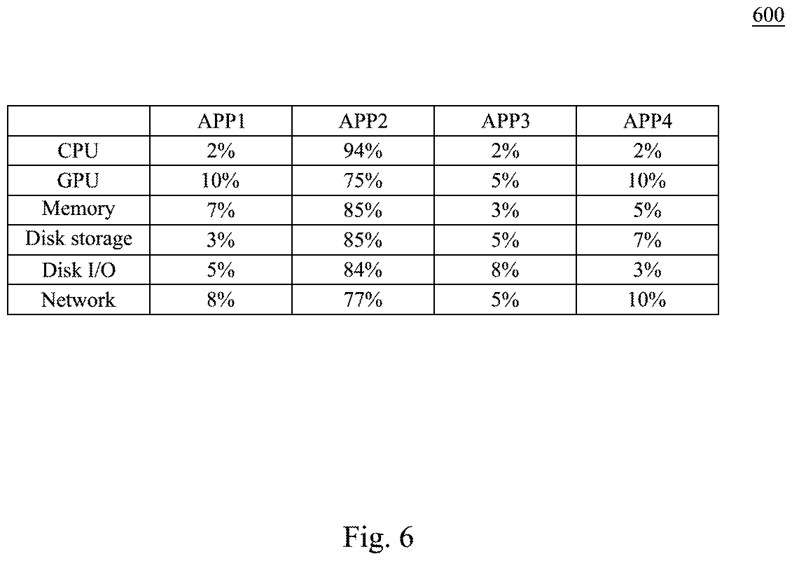

Reference is made to FIG. 5 and FIG. 6. FIG. 5 is a schematic diagram illustrating an allocation example 500 according to some embodiments of the present disclosure. FIG. 6 is a schematic diagram illustrating another allocation example 600 according to some embodiments of the present disclosure. Assume that the application APP1 is an image analysis application, the application APP2 is a map application, the application APP3 is a statistics application, the application APP4 is a setting system application. For the application APP1, the GPU resource is the most important. For the application APP2, the CPU resource is the most important.

As illustrated in FIG. 5, when the application APP1 is focused, the GPU resource allocated to the application APP1 includes an allocated weighting value of 95%, which is the highest compared to the other allocated weighting values of the GPU resource allocated to the other applications APP2 to APP4. Moreover, the allocated weighting value of the GPU resource allocated to the application APP1 is higher than the allocated weighting values of the other resources (for example, the CPU resource) allocated to the application APP1.

As illustrated in FIG. 6, when the application APP2 is focused, the CPU resource allocated to the application APP2 includes an allocated weighting value of 94%, which is the highest compared to the other allocated weighting values of the CPU resource allocated to the other applications APP1, APP3 and APP4. Moreover, the allocated weighting value of the CPU resource allocated to the application APP2 is higher than the allocated weighting values of the other resources (for example, the GPU source) allocated to the application APP2.

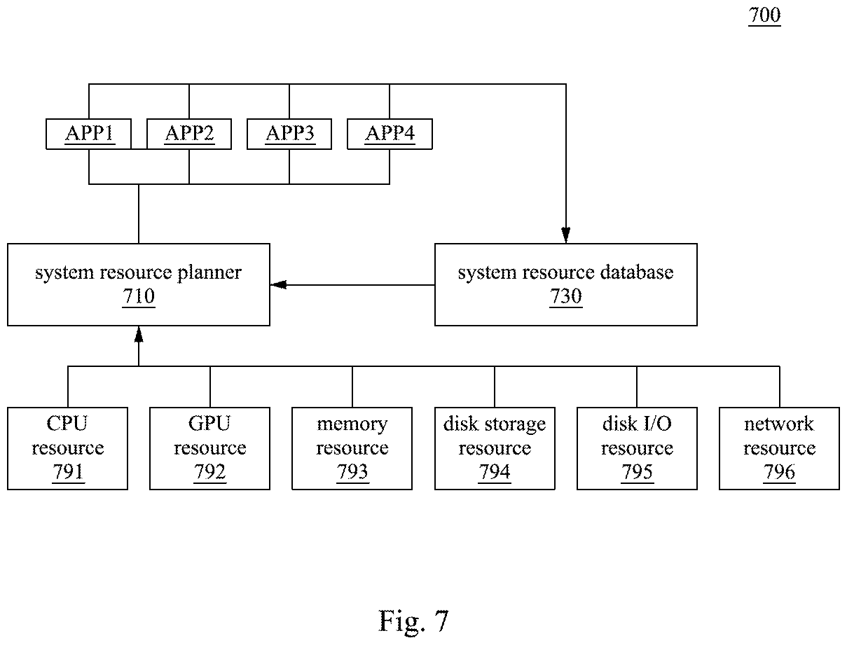

Reference is made to FIG. 7. FIG. 7 is a schematic diagram illustrating an example of resource allocation according to some embodiments of the present disclosure. In some embodiments, the security system 100 in FIG. 1 further includes a system resource database 730, and the system resource database 730 is configured to store the predetermined maximum weighting values and the predetermined minimum weighting values.

In some embodiments, the security system 100 in FIG. 1 further includes a system resource planner 710, and the system resource planner 710 is configured to allocate the resources (for example, the CPU resource 791, the GPU resource 792, the memory resource 793, the disk storage resource 794, the disk I/O resource 795, and the network resource 796) to the applications APP1 to APP4 according to the predetermined maximum weighting values and the predetermined minimum weighting values stored in the system resource database 730.

The embodiments of the present disclosure provide a security system and a control method, by controlling the applications according to the relationships between the applications, the applications are managed more efficiently. Secondly, by setting the drawing parameters, images from different input signals may be merged to generate a screen picture. Thirdly, by allocating the resources according to the preset maximum weighting values and the preset minimum weighting values, the resources may be allocated more efficiently.

In some embodiments, the processor 110 can be, but are not limited to being, a single processor or an integration of multiple microprocessors such as CPUs or GPUs. The microprocessors are electrically coupled to the memory in order to access the at least one instruction. According to the at least one instruction, the above-mentioned adjusting method can be performed. In some embodiments, the memory 130 can be a flash memory, a HDD, a SSD (Solid State Disk), a DRAM (Dynamic Random Access Memory) or a SRAM (Static Random-Access Memory). In some embodiments, the memory 130 can be a non-transitory computer readable medium stored with at least one instruction associated with a control method. The at least one instruction can be accessed and executed by the processor 110. In some embodiments, the I/O circuit 150 can be a circuit with functions of sending/receiving messages/information or other similar functions.

In addition, it should be noted that in the operations of the above mentioned control method 200, no particular sequence is required unless otherwise specified. Moreover, the operations may also be performed simultaneously or the execution times thereof may at least partially overlap.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A security system, comprising:
a memory, configured to store a plurality of applications, wherein the plurality of applications comprise a plurality of relationships; and
a processor, coupled to the memory, wherein the processor is configured to manage the plurality of applications according to the plurality of relationships and at least one of a time driven method and an event driven method, wherein the plurality of relationships comprise a parent-child relationship, a function-group relationship, and an app-type relationship;
wherein the processor is further configured to receive a plurality of input signals from a plurality of sources, and to display a screen picture of the plurality of input signals according to a plurality of drawing parameters;
wherein when the plurality of applications are running, the processor is further configured to allocate a plurality of resources of the security system to the plurality of applications according to a plurality of weighting values.

2. The security system of claim 1, wherein the processor is further configured to send a plurality of messages between the plurality of applications according to the plurality of relationships, and to change a plurality of execution statuses of the plurality of applications according to the plurality of relationships.

3. The security system of claim 2, wherein when a first relationship between a first application and a second application is the parent-child relationship, and the first application works as a parent application of the second application, the processor is further configured to send a first message from the first application to the second application;
wherein when the first relationship is the function-group relationship, the processor is further configured to send the first message to the first application and the second application according to the function-group relationship;
wherein when the first relationship is the app-type relationship, the processor is further configured to send the first message to the first application and the second application according to the app-type relationship.

4. The security system of claim 1, wherein when a first application is managed with the time driven method, the first application is executed or closed when a predetermined time condition is reached;
wherein when the first application is managed with the event driven method, the first application is executed or closed when a predetermined event condition is reached.

5. The security system of claim 1, wherein when a first application is managed with the time driven method, the first application receives or sends a message when a predetermined time condition is reached;
wherein when the first application is managed with the event driven method, the first application receives or sends the message when a predetermined event condition is reached.

6. The security system of claim 1, wherein the processor is further configured to adjust the plurality of drawing parameters according to the time driven method, the event driven method, or a user driver method, wherein the time driven method includes a time condition, wherein the event driven method includes an event condition, wherein the user driven method includes a user condition.

7. The security system of claim 1, wherein the processor is further configured to merge the plurality of input signals to generate the screen picture with a horizontal stitching and transparent method, a vertical stitching and covering method, or a vertical stitching and transparent method.

8. The security system of claim 1, wherein the processor is further configured to merge the plurality of input signals according to at least one of a scripted condition, wherein the plurality of drawing parameters are adjusted dynamically.

9. The security system of claim 1, wherein for a first application comprising a plurality of first weighting values, each of the first weighting values corresponds to one of the plurality of resources in correspondence.

10. The security system of claim 9, wherein each of the plurality of first weighting values comprise a maximum weighting value and a minimum weighting value, wherein the maximum weighting value and the minimum weighting value are predetermined.

11. The security system of claim 10, wherein when the first application is focused, each of the plurality of resources are allocated to the first application with an allocated weighting value higher than the minimum weighting value, and when the first application is not focused, each of the plurality of resources are allocated to the first application with the allocated weighting value lower than the maximum weighting value.

12. A control method, suitable for a security system, wherein the security system comprises a plurality of applications with a plurality of relationships, wherein the control method comprises:
managing the plurality of applications according to the plurality of relationships and at least one of a time driven method and an event driven method by a processor of the security system, wherein the plurality of relationships comprise a parent-child relationship, a function-group relationship, and an app-type relationship;
receiving a plurality of input signals from a plurality of sources and displaying a screen picture of the plurality of input signals according to a plurality of drawing parameters by the processor; and
allocating a plurality of resources of the security system to the plurality of applications according to a plurality of weighting values by the processor when the plurality of applications are running.

13. The control method of claim 12, wherein when a first relationship between a first application and a second application is the parent-child relationship, the first application works as a parent application of the second application, and the control method further comprises sending a first message from the first application to the second application;
wherein when the first relationship is the function-group relationship, the control method further comprises sending the first message to the first application and the second application according to the function-group relationship;
wherein when the first relationship is the app-type relationship, the processor is further configured to send the first message to the first application and the second application according to the app-type relationship.

14. The control method of claim 12, further comprising:
executing or closing a first application when a predetermined time condition is reached if the first application is managed with the time driven method; and
executing the first application when a predetermined event condition is reached when the first application is managed with the event driven method.

15. The control method of claim 12, further comprising:
controlling a first application to receive or send a message when a predetermined time condition is reached if the first application is managed with the time driven method; and
controlling the first application to receive or send the message when a predetermined event condition is reached if the first application is managed with the event driven method.

16. The control method of claim 12, further comprising:
adjusting the plurality of drawing parameters according to the time driven method, the event driven method, or a user driver method, wherein the time driven method includes a time condition, wherein the event driven method includes an event condition, wherein the user driven method includes a user condition.

17. The control method of claim 12, further comprising:
merging the plurality of input signals to generate the screen picture with a horizontal stitching and transparent method, a vertical stitching and covering method, or a vertical stitching and transparent method.

18. The control method of claim 12, further comprising:
merging the plurality of input signals according to at least one of a scripted condition, wherein the plurality of drawing parameters are adjusted dynamically.

19. The control method of claim 18, wherein for a first application comprising a plurality of first weighting values, each of the first weighting values corresponds to one of the plurality of resources in correspondence;
wherein each of the plurality of first weighting values comprises a maximum weighting value and a minimum weighting value, wherein the maximum weighting value and the minimum weighting value are predetermined.

20. The control method of claim 19, further comprising:
allocating the plurality of resources to the first application with an allocated weighting value higher than the minimum weighting value when the first application is focused; and
allocating the plurality of resources to the first application with the allocated weighting value lower than the maximum weighting value when the first application is not focused.
